(19) United States
(12) Patent Application Publication
(10) Pub. No.: US 2020/0156312 A1
(43) Pub. Date: May 21, 2020

(54) 3D PRINTING DEVICE WITH INFRARED THERMOMETER CALIBRATION STRUCTURES

(71) Applicants: XYZPRINTING, INC., NEW TAIPEI CITY (TW); KINPO ELECTRONICS, INC., NEW TAIPEI CITY (TW)

(72) Inventors: Chao-Ming CHEN, NEW TAIPEI CITY (TW); Chia-Wu LIAO, NEW TAIPEI CITY (TW); Chia-Hsien LAI, NEW TAIPEI CITY (TW)

(21) Appl. No.: 16/239,468

(22) Filed: Jan. 3, 2019

(30) Foreign Application Priority Data
Nov. 21, 2018 (CN) 201811391702.1

(51) Int. Cl. B29C 64/153; B29C 64/245; B29C 64/386; B29C 64/295; B29C 64/255

(52) U.S. Cl. CPC B29C 64/153; B29C 64/245; B33Y 10/00; B29C 64/295; B29C 64/255; B29C 64/386

(57) ABSTRACT

A 3D printing device having a main body, a forming platform, an infrared thermometer, a heater, a thermocouple and a calibrator is provided. A forming chamber is defined in the main body. The forming platform is accommodated in the forming chamber, and a top surface thereof forms a bottom of the forming chamber. A reference surface is defined in the forming chamber, and the reference surface has an infrared radiance approximate to the powder. The infrared thermometer in the main body is disposed above and toward the reference surface. The heater is disposed in the main body to conductively heat the reference surface. The thermocouple is arranged adjacent to the reference surface. The calibrator is electrically connected to the infrared thermometer and the thermocouple to compare respective measured temperatures of the reference surface, and thereby determine if the infrared thermometer should be cleared.

### BACKGROUND OF THE INVENTION

### 1. Technical Field

The technical field relates to 3D printing device, in particular to a 3D printing device with infrared thermometer calibration structures.

### 2. Description of Related Art

The invention relates to a laser sintering and curing type of 3D printing device, and its working principle is to lay a layer of powder on the platform, and then to burn a part of the predetermined area in the layer of the powder by laser, thereby solidifying the powder in the predetermined area into a slicer, and then cutting the slicer and lay a powder layer on the slicer to carry out the sintering and solidifying of the next slicer. At last, repeat the foregoing steps to stack the slicers and finally form the finished product.

In general, to speed up the speed of printing, the powder of the surface must be preheated around the melting point, take plastic for example is about 170° C. Hence, the laser can quickly heat the preheated powder in a predetermined area to the melting point for melting. In order to maintain the temperature of the powder of the surface layer, the temperature of powder of the surface layer is generally measured by an infrared thermometer. However, once the powder is attached to the infrared thermometer, the measured temperature will be incorrect. The existing infrared thermometer of the 3D printing device only can correct itself if it deviates from the default value, but it is impossible to judge whether the measured temperature is biased. Generally, it needs to be disassembled and then corrected by a blackbody furnace to determine whether the temperature is deviated or not. Moreover, the powder is hard to be removed when it is attached to the infrared thermometer for a long time because the power will be melted and fixed in the infrared thermometer in the high temperature environment of the 3D printing device. Therefore, existing infrared thermometers must be disassembled and cleaned frequently to ensure the accuracy, and the frequency of maintenance is too high.

In view of the foregoing, the inventor made various studies to improve the above-mentioned problems, on the basis of which the present invention is accomplished.

### SUMMARY OF THE INVENTION

The disclosure is directed to a 3D printing device with infrared thermometer calibration structures.

One of the exemplary embodiments provides a 3D printing device with infrared thermometer calibration structures for melting and solidifying powder comprising a main body, a forming platform, an infrared thermometer, a heater, a thermocouple and a calibration unit. The main body has formed a forming chamber. The forming platform is accommodated in the forming chamber, and a top surface of the forming platform is configured to be an inner bottom of the forming chamber. There is a reference surface defined on a top surface of the forming platform, and an infrared emissivity of the reference surface is approximated to an infrared emissivity of the powder at a corresponded operating temperature. The infrared thermometer is disposed in the main body, and the infrared thermometer is suspended above the reference surface and disposed toward the reference surface. The heater is disposed in the main body and thermally connected with the reference surface for heating the reference surface by heat conduction. The thermocouple is arranged adjacent to the reference surface. The calibration unit is electrically connected to the infrared thermometer and the thermocouple to compare temperatures of the reference surface measured by the infrared thermometer and the thermocouple respectively.

One of the exemplary embodiments, the 3D printing device further includes a lifting/lowering mechanism, wherein the lifting/lowering mechanism is disposed below the forming chamber, and the lifting/lowering mechanism the forming platform.

One of the exemplary embodiments, the powder is plastic, and the infrared emissivity of the reference surface and the powder are both 0.95, wherein a black tape is attached to the top surface of the forming platform, and the reference surface is located at the black tape.

One of the exemplary embodiments, an infrared emissivity of the top surface of the forming platform is approximated to an infrared emissivity of the powder to be configured as the reference surface.

One of the exemplary embodiments, the 3D printing device further includes a laser disposed in the main body and suspended above the forming platform.

One of the exemplary embodiments, the 3D printing device further includes a heating lamp disposed in the main body and suspended above the forming platform.

One of the exemplary embodiments, the thermocouple is embedded in a bottom of the forming platform.

One of the exemplary embodiments, there is a powder supply tank disposed adjacent to the forming chamber in the main body.

One of the exemplary embodiments, the top surface of the forming platform is located at an opening of the forming chamber, and the infrared thermometer is aligned with the reference surface.

One of the exemplary embodiments, the heater is plate-shaped and stacked on a bottom of the forming platform; the reference surface is disposed on the top surface of the forming platform.

One of the exemplary embodiments, to compare that whether the temperatures of the forming platform measured by the infrared thermometer and the thermocouple are the same so as to determine the measured value of the infrared thermometer is accurate or not and further to determine whether the infrared thermometer is dirty or not for cleaning.

### BRIEF DESCRIPTION OF THE DRAWINGS

FIG. 1 to FIG. 3 are schematic views of 3D printing device with infrared thermometer calibration structures according to an embodiment of the present invention.

### DETAILED DESCRIPTION OF THE INVENTION

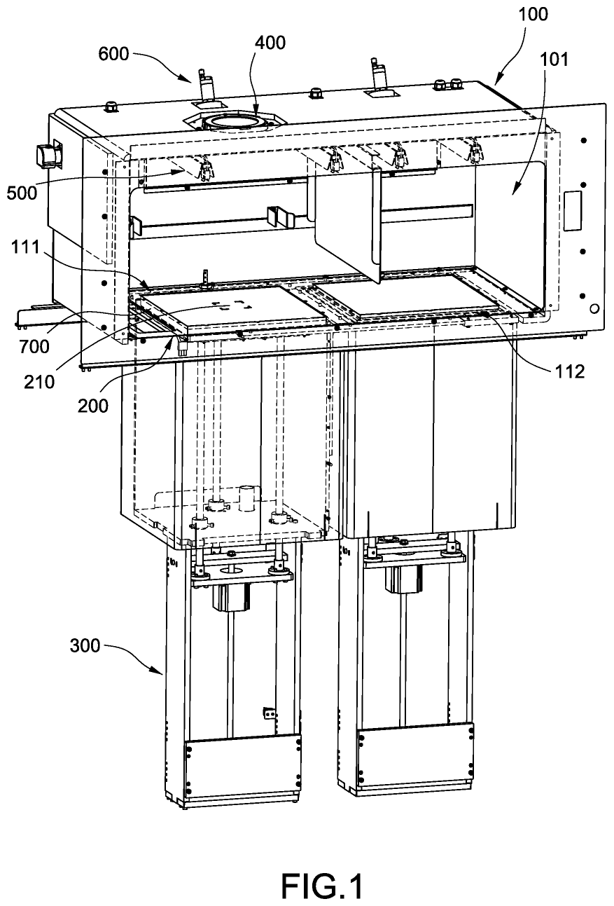

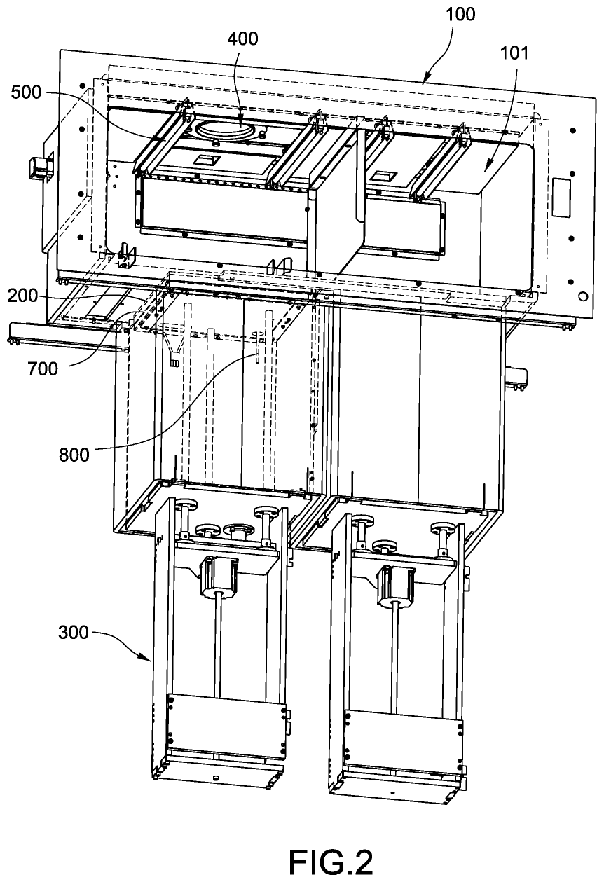

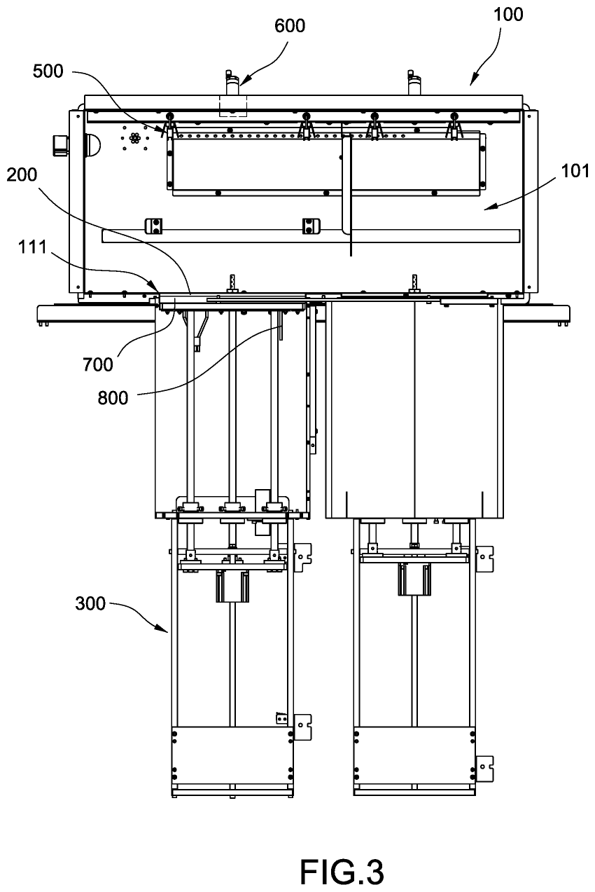

Please refer to FIG. 1 to FIG. 3, the present invention provides a 3D printing device with infrared thermometer 600 calibration structures according to a first embodiment of the present invention for sintering and solidifying powder to make a product by laminate forming. In the present disclosed example, the powder is preferably plastic, and its working temperature is about 170 degrees. The working temperature is generally lower than the melting point of the powder and approximate to the melting point of the powder, but not limited to this embodiment. The infrared emissivity of the aforementioned powder at the working temperature is 0.95.

In the present disclosed example, the 3D printing device of the present invention includes a main body 100, a forming platform 200, a lifting/lowering mechanism 300, a laser 400, a heating lamp 500, an infrared thermometer 600, a heater 700, a thermocouple 800 and a calibration unit (not shown).

The main body 100 has formed a working room 101, and the working chamber 101 has formed a forming chamber 101 at a bottom, and there is a powder supply tank 112 disposed adjacent to the forming chamber 111. The powder supply tank 112 is provided for containing the powder.

The forming platform 200 is accommodated in the forming chamber 111, and a top surface of the forming platform 200 is configured to be an inner bottom of the forming chamber 111. There is a reference surface 210 defined in an inner wall of the forming chamber 111, and an infrared emissivity of the reference surface 210 is approximated to an infrared emissivity of the powder at a corresponded operating temperature. In the present disclosed example, the reference surface 210 is preferably provided at the top surface of the forming platform 200, but the location is not limited in the present invention, for example, the reference surface 210 can be provided at an inner wall of the forming chamber 111. In the present disclosed example, the infrared emissivity of the reference surface and the powder are preferably both 0.95. However, the reference surfaces 210 can be configured with different infrared emissivity depending on different powders and corresponding operating temperatures.

Preferably, a black tape can be attached to the top surface of the forming platform 200, and the reference surface 210 is located at the black tape. However, the present invention is not limited thereto. For example, when the infrared emissivity of the top surface of the forming platform 200 is approximated to the infrared emissivity of the powder, the top surface 210 of the forming platform 200 itself can be provides as the reference surface 210.

The lifting/lowering mechanism 300 is disposed below the forming chamber 111, and the lifting/lowering mechanism 300 connects and drives the forming platform 200 to move up and down in the forming chamber 111. When the forming platform 200 rises up to the apex of the stroke, the top surface of the forming platform 200 is located at the opening of the forming chamber 111. When a slicer of 3D object is formed, the powder in the powder supply tank 112 is laid flat on the forming platform 200 to configure a surface powder located at the opening of the forming chamber 111.

The laser 400 is disposed in the working room 101 of the main body 100 and suspended above the forming platform 200. The laser 400 is disposed downwardly toward the forming platform 200 and is capable of emitting a laser beam to the forming platform 200 to melt a portion of the predetermined area of the surface powder; thereby curing the powder in the predetermined area into a slicer. Then the powder of next slicer will be laid on the slicer for performing the processes of sintering and curing of the next slicer. At last, to repeat the foregoing steps and stack the slicers to constitute the finished product eventually.

The heating lamp 500 is disposed in the main body 100 and suspended above the forming platform 200. The heat lamp 500 heats the aforementioned surface powder by heat radiation so that the surface powder is preheated to the working temperature and close to the melting point thereof. Therefore, the laser 400 does not need to heat the powder at the room temperature to the melting point, thereby the forming speed will be speeded up.

The infrared thermometer 600 is disposed in the main body 100. The infrared thermometer 600 is suspended above the reference surface 210 and disposed toward the reference surface 210 for getting the temperature of the surface powder by measuring the infrared emissivity of the opening of the forming chamber 111. When the top surface of the forming platform 200 is located at an opening of the forming chamber 111, the infrared thermometer 600 is aligned with the reference surface 210.

The heater 700 is disposed in the main body 100 and thermally connected with the reference surface 210 by heat conduction. In the present disclosed example, the heater 700 is preferably plate-shaped and stacked on a bottom of the forming platform 200 for thermally connecting with the reference surface 210 by heat conduction. The heater 700 is disposed at any position where can directly contact the forming platform 200 for heating the forming platform 200 by heat conduction. The heater 700 can also be disposed corresponding to the inner side wall of the forming chamber 111. During the forming process, the temperature of the powder in the forming tank 111 is maintained through the heater 700 so that the temperature difference between the powder in the forming chamber 111 and the surface powder at the opening of the forming chamber 111 will not too large to prevent the product from being cracked.

The thermocouple is arranged to contact the forming platform 200, and the temperature of the forming platform 200 will be measured through contacting. In the present embodiment, the thermocouple is preferably embedded in a bottom of the forming platform 200.

The calibration unit is electrically connected to the infrared thermometer 600 and the thermocouple 800 to compare temperatures of the forming platform 200 measured by the infrared thermometer 600 and the thermocouple 800 respectively.

Before the 3D printing device with infrared thermometer 600 calibration structures of the present disclosed example starting to lay the powder for printing, the reference surface 210 of the top of the forming platform 200 is raised at the opening of the forming chamber 111 by the lifting/lowering mechanism 300, and the infrared thermometer 600 is corrected by the reference surface 210 according to the default value of the infrared thermometer 600. The forming platform 200 is uniformly heated by the heater 700 to the operating temperature of the powder, and the temperature of the forming platform 200 is measured by the thermocouple 800. When the thermocouple 800 measures that the temperature of the forming platform 200 is heated to reach the operating temperature of the powder, the temperature of the forming platform 200 is measured by the infrared thermometer 600. Then the calibration unit compares that whether the temperature of the forming platform 200 measured by the infrared thermometer 600 and the thermocouple 800 is the same or not. If the temperatures of the forming platform 200 measured by the infrared thermometer 600 and the thermocouple 800 are the same, it can be determined that the measured value of the infrared thermometer 600 is accurate. If the temperatures of the forming platform 200 measured by the infrared thermometer 600 and the thermocouple 800 are different, it can be determined that the infrared thermometer 600 is dirty and needs to be cleaned. Therefore, the 3D printing device of the present disclosed example can instantly determine the need of cleaning when the infrared thermometer 600 is dirty and out of allowance; thus not only the frequency of maintenance can be reduced but also particles of the powder can be prevented from being attached to the infrared thermometer 600.

In summary, the heat sink structure with the heat exchange mechanism according to the present invention certainly can achieve the anticipated objects and improve the defects of the traditional techniques, and has industry applicability, novelty and non-obviousness, so the present invention completely meets the requirements of patentability. Therefore, a request to patent the present invention is filed according to patent laws. Examination is kindly requested, and allowance of the present application is solicited to protect the rights of the inventor.

What is claimed is:

1. A 3D printing device with infrared thermometer calibration structures for melting and solidifying powder, the 3D printer device comprising:
a main body having a forming chamber formed therein;
a forming platform accommodated in the forming chamber, and a top surface of the forming platform being configured to be an inner bottom of the forming chamber; a reference surface being defined in an inner wall of the forming chamber, and an infrared emissivity of the reference surface being approximated to an infrared emissivity of the powder at a corresponded operating temperature;
an infrared thermometer disposed in the main body, the infrared thermometer being suspended above the reference surface and disposed toward the reference surface;
a heater disposed in the main body and thermally connected with the reference surface for heating the reference surface by heat conduction;
a thermocouple arranged adjacent to the reference surface; and
a calibration unit electrically connected to the infrared thermometer and the thermocouple to compare temperatures of the reference surface measured by the infrared thermometer and the thermocouple respectively.

2. The 3D printing device with infrared thermometer calibration structures according to claim 1, further including a lifting/lowering mechanism, wherein the lifting/lowering mechanism is disposed below the forming chamber, and the lifting/lowering mechanism connects and drives the forming platform.

3. The 3D printing device with infrared thermometer calibration structures according to claim 1, wherein the powder is plastic, and the infrared emissivity of the reference surface and the powder is 0.95.

4. The 3D printing device with infrared thermometer calibration structures according to claim 3, wherein a black tape is attached to the top surface of the forming platform, and the reference surface is located at the black tape.

5. The 3D printing device with infrared thermometer calibration structures according to claim 1, wherein an infrared emissivity of the top surface of the forming platform is approximated to an infrared emissivity of the powder to be configured as the reference surface.

6. The 3D printing device with infrared thermometer calibration structures according to claim 1, further including a laser disposed in the main body and suspended above the forming platform.

7. The 3D printing device with infrared thermometer calibration structures according to claim 1, further including a heating lamp disposed in the main body and suspended above the forming platform.

8. The 3D printing device with infrared thermometer calibration structures according to claim 1, wherein the thermocouple is embedded in a bottom of the forming platform.

9. The 3D printing device with infrared thermometer calibration structures according to claim 1, wherein a powder supply tank is disposed adjacent to the forming chamber in the main body.

10. The 3D printing device with infrared thermometer calibration structures according to claim 1, wherein when the top surface of the forming platform is located at an opening of the forming chamber, the infrared thermometer is aligned with the reference surface.

11. The 3D printing device with infrared thermometer calibration structures according to claim 1, wherein the heater is plate-shaped and stacked on a bottom of the forming platform.

12. The 3D printing device with infrared thermometer calibration structures according to claim 1, wherein the reference surface is disposed on the top surface of the forming platform.
